(19) United States
(12) Patent Application Publication
(10) Pub. No.: US 2012/0313847 A1
(43) Pub. Date: Dec. 13, 2012

(54) METHOD AND APPARATUS FOR CONTEXTUAL GESTURE RECOGNITION

(75) Inventors: Peter Pal Boda, Palo Alto, CA (US); Hawk Yin Pang, San Jose, CA (US); John Paul Shen, San Jose, CA (US); Zhigang Liu, Sunnyvale, CA (US)

(73) Assignee: Nokia Corporation, Espoo (FI)

(21) Appl. No.: 13/156,557

(22) Filed: Jun. 9, 2011

(51) Int. Cl. G09G 5/00

(52) U.S. Cl. 345/156

(57) ABSTRACT

Methods, apparatuses and computer program products are provided for facilitating interaction via motion gestures. A method may include receiving an indication of at least one motion gesture made with a device. The method may further include determining a contextual state of a device. The method may additionally include determining, by a processor, a relationship between the at least one motion gesture and each of a plurality of predefined motion gestures and causing, based at least in part on the determined relationship, the device to perform an action associated with a respective predefined gesture. Corresponding apparatuses and computer program products are also provided.

### TECHNOLOGICAL FIELD

Example embodiments of the present invention relate generally to user interface technology and, more particularly, relate to methods and apparatuses for facilitating interaction with a user interface via motion gestures.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

In many situations, it may be desirable for the user to interface with a device such as a mobile terminal for provision of an application or service. A user's experience during certain applications such as, for example, web browsing or navigating through content may be performed through existing methods of a touch screen interface or a tactile keypad; however as a small size is often desirable for portable devices, alternative methods for a user interface to provide input may be similarly desirable. Physical device input elements, such as keys of a keypad or touch screens may have limited size thereby limiting the number of available inputs. Further enhancing user interface options may improve a user's experience and increase the popularity and functionality of a device.

### BRIEF SUMMARY

Methods, apparatuses, and computer program products are herein provided for facilitating interaction with a user interface via motion gestures. Further, one example embodiment may provide a method, apparatus, and computing program product for interpreting a motion gesture input in light of the context of the device. In this embodiment, different actions may be performed in response to the same motion gesture input depending upon the context of the device. Thus, the method, apparatus and computer program product of an embodiment of the present invention may provide a more robust and contextually tailored set of actions to be directed by motion gestures, such as when a user holds and moves a mobile device or other implementation, such as a combination of a mobile device and a wirelessly connected wearable bracelet, with his hand or otherwise.

In one example embodiment, a method may include receiving an indication of at least one motion gesture made with a device. The method may also include determining a contextual state of the device. Further, the method may include determining, by a processor, a relationship between the at least one motion gesture and each of a plurality of predefined motion gestures that are associated with the contextual state of the device. Further, the method may include causing, based at least in part on the relationship, the device to perform an action associated with a respective predefined gesture.

According to one example embodiment, the method may include determining a motion gesture library associated with the contextual state of the device, the motion gesture library comprising a plurality of motion gestures. In addition, the method may comprise determining a normalized accumulated distance between the at least one motion gesture and each of the plurality of predefined motion gestures that are associated with the contextual state of the device.

In another example embodiment, an apparatus may comprise at least one processor and at least one memory storing computer program code, wherein the at least one memory and stored computer program code are configured, with the at least one processor, to cause the apparatus to at least receive an indication of at least one motion gesture made with the apparatus. Further, the apparatus may comprise at least one processor and at least one memory storing computer program code, wherein the at least one memory and stored computer program code are configured, with the at least one processor, to cause the apparatus to at least determine a contextual state of the apparatus. In addition, the apparatus may comprise at least one processor and at least one memory storing computer program code, wherein the at least one memory and stored computer program code are configured, with the at least one processor, to cause the apparatus to at least determine a relationship between the at least one motion gesture and each of a plurality of predefined motion gestures that are associated with the contextual state of the apparatus. According to one embodiment of the present invention, the apparatus may comprise at least one processor and at least one memory storing computer program code, wherein the at least one memory and stored computer program code are configured, with the at least one processor, to cause the apparatus to at least cause, based at least in part on the determined relationship, the apparatus to perform an action associated with a respective predefined gesture.

In another example embodiment, a computer program product is provided. The computer program product of this example embodiment may include at least one non-transitory computer-readable storage medium having computer-readable program instructions stored therein. The computer-readable program instructions may comprise program instructions configured to cause an apparatus to perform a method comprising receiving an indication of at least one motion gesture made with a device. The method may also include determining a contextual state of the device. Further, the method may include determining a relationship between the at least one motion gesture and each of a plurality of predefined motion gestures that are associated with the contextual state of the device. The method may also include causing, based at least in part on the determined relationship, the device to perform an action associated with a respective predefined gesture.

In another example embodiment, an apparatus may include means for receiving an indication of at least one motion gesture made with a device. The apparatus may also include means for determining a contextual state of the device. Further, the apparatus may include means for determining, by a processor, a relationship between the at least one motion gesture and each of a plurality of predefined motion gestures that are associated with the contextual state of the device. Further, the apparatus may include means for causing, based at least in part on the relationship, the device to perform an action associated with a respective predefined gesture.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for facilitating interaction via motion gestures according to an example embodiment;

FIG. 2 is a schematic block diagram of a mobile terminal according to an example embodiment;

FIG. 3 illustrates a flowchart according to an example method for facilitating interaction via motion gestures according to an example embodiment; and

FIG. 4 illustrates a flowchart according to an example method for facilitating interaction via motion gestures according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Some embodiments of the present invention may relate to a provision of a mechanism by which the user interface is enhanced beyond the touch of virtual or physical keys or physical gestures interpreted by a touch screen. The physical manipulation or motion of a device may be interpreted by the device to be an input. Further, motion of a device through a two-dimensional or three-dimensional pattern may be interpreted by the device as an input. Beyond the two-dimensional or three-dimensional pattern, the temporal relation between a plurality of motions of a device through two-dimensional or three-dimensional patterns may provide additional levels of input that are interpreted by the device.

Embodiments of the present invention may enhance the finite set of movement patterns recognized by recognizing a contextual state of the device (e.g., a user input motion that is aware of the active application of the device) to further influence how a single motion or finite set of motions may be interpreted as various user inputs to result in a wider variety of user input effects. The contextual state may include an application which is currently active, such as a primary application in use on a device, such as a music player program, a text message program, or a voice call among others. The contextual state may also include the device being in a “home” state, such as when a home screen is displayed on the device, the home screen including any number of icons representative of one or more applications that are active on the display device. Further still, the contextual state may include a location of the device, such as when a user and the device are located at the workplace, when a user and the device are located at home, when the user and device are located at a holiday destination, and/or the like, such as may be detected by a sensor. In addition, the contextual state of the device may include a temporal measurement, such as the amount of time after an application has been closed, the amount of time after a phone call has been completed, the amount of time after a short message service (SMS) message has been received, and/or the like, such as may be detected by a sensor. In another embodiment, the contextual state of the device may include whether the device is experiencing sustained movement (e.g., a GPS speed detected indicating walking, running, cycling, traveling in an automobile, or traveling in an airplane).

Some embodiments of the present invention may relate to the provision of a mechanism by which substantively different user interface effects may be performed for a motion gesture based on a contextual state of the device, such as a device event, such as receiving a phone call, receiving a calendar event alarm, receiving a SMS message, and/or the like. Thus, for example, in the case of a particular contextual state of the device (e.g., receiving a phone call while traveling in an automobile), a first type of user interface effect may be induced. For example, a user performing an “S” gesture while receiving a phone call while traveling in an automobile may induce the device to answer the phone call and place the device in speakerphone mode. In another embodiment, a user performing an “S” gesture when receiving an event alarm may silence the device. According to one embodiment, a user performing an “S” gesture when receiving a SMS message may open and display the SMS message for the user to review.

Other embodiments of the present invention may provide for substantively different user interface effects to be performed for a motion gesture based on a contextual state of the device, such as the location of the device. Thus, for example, when a user and the device are located at the workplace, a user performing a “P” gesture will open the phonebook that is associated with the workplace. In another embodiment, when a user and the device are located at home, a user performing a “P” gesture will open the phonebook that is associated with the user's personal home life. According to one embodiment of the present invention, the device may include a dual SIM, wherein a first SIM may be associated with a user's work environment and a second SIM may be associated with a user's private or personal environment. In yet another embodiment, when a user and the device are located at a vacation destination, a user performing a “P” gesture will open the phonebook associated with tourist attractions. As such, a user may perform a “P” gesture followed by a “Z” gesture while being located at the workplace to initiate a phone call to “Zhigang,” a work colleague the user communicates with on a frequent basis. In another embodiment, a user may perform a “P” gesture followed by a “Z” gesture while being located at home to initiate a phone call to “Zoe,” a close personal friend of the user. In another embodiment, when a user performs a “P” gesture followed by a “Z” gesture while being located at the workplace and a number of the user contacts have names that begin with “Z,” the device may enter a dialogue state requesting the user to indicate which contact to call or suggest additional motion gestures to indicate which contact to call.

Other embodiments of the present invention may provide for substantively different user interface effects to be performed for a motion gesture based on the contextual state of the device, such as a temporal relationship between a plurality of motion gestures performed by a user with the device, a temporal relationship between a motion gesture and a device event, such as the completion of a phone call, and/or the like. For example, when a user concludes a phone call with “Hawk”, a user performing a “C” gesture may open the calendar application with a new meeting invitation item for Hawk. In another example embodiment, when a user concludes a phone call with “Hawk”, a user performing an “S” gesture may open a text messaging application with a message addressed to Hawk. Further still, the subject line of the text message addressed to Hawk may be predefined, such as “Re: Our phone call today.” In another example embodiment, the contextual state of the device, such as the completion of a phone call, may be taken into consideration if a motion gesture is preceded with a simple motion gesture that enables reference to the device event. For example, a user may perform a motion gesture comprising moving the device in a horizontal line from left to right to indicate the contextual state of the device should be considered. As such, a user may perform the horizontal line gesture followed by a “C” gesture after the completion of a phone call with “Hawk” to open a calendar application with a new meeting invitation item for Hawk.

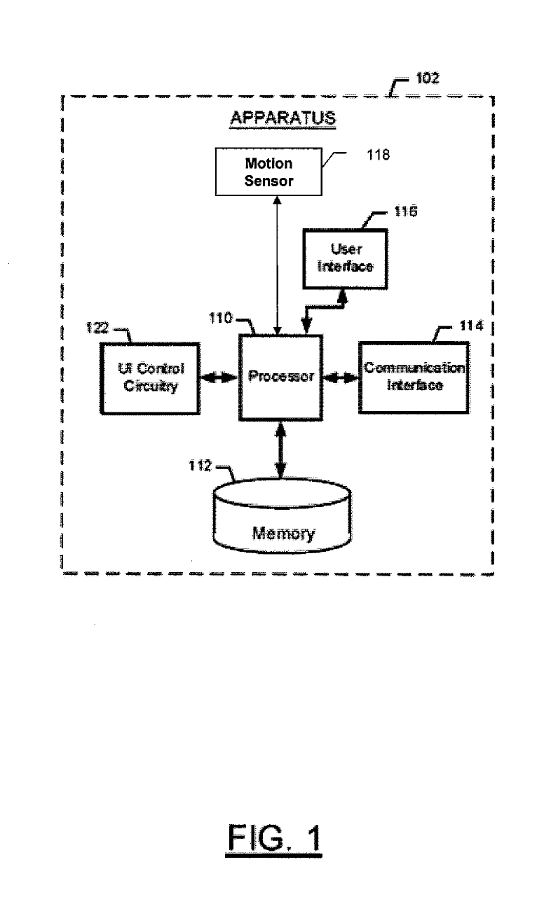

FIG. 1 illustrates a block diagram of an apparatus 102 for facilitating interaction with a user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

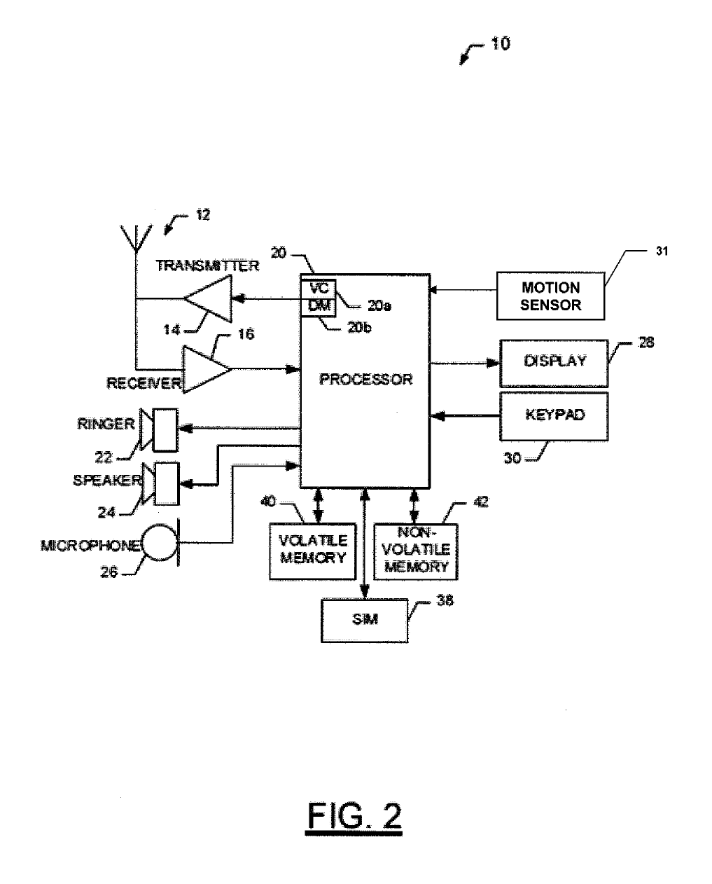

The apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), a motion sensor 31 and/or other input device. In embodiments including a keypad, the keypad may comprise numeric (0-9) and related keys (#, *), and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in a more general example embodiment, the apparatus 102 includes various means for performing the various functions herein described. These means may comprise one or more of a processor 110, memory 112, communication interface 114, user interface 116, motion sensor 118 or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof. Further, although the apparatus 102 illustrated in FIG. 1 may be sufficient to control operations, such as detecting a motion gesture and/or the like according to example embodiments of the invention, another embodiment of an apparatus may be simplified so as to require a controlling device or separate device, such as a mobile terminal according to FIG. 2, to operatively control the functionality of a motion sensor, such as a wearable bracelet and/or the like. In one embodiment, a wearable bracelet may be configured to detect a motion gesture, process the motion gesture, and detect which motion gesture is performed. In another embodiment, a wearable bracelet may be configured to communicate a signal representative of a motion gesture to a mobile device for further processing, detection, classification and/or the like.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, motion sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, a motion sensor, and/or other input/output mechanisms. The user interface 116 may be in communication with the memory 112, communication interface 114, and/or UI control circuitry 122, such as via a bus.

In some example embodiments, the apparatus 102 comprises a motion sensor 118. In alternative example embodiments, such as in embodiments wherein the apparatus 102 is embodied as a chip or chipset, the apparatus 102 may be operatively connected with the motion sensor 118 such that the apparatus 102 may control the motion sensor 118, receive an indication of and/or otherwise determine a user input (e.g., a motion gesture input, and/or the like) to the motion sensor 118, and/or the like. The motion sensor 118 may comprise any type of sensor capable of receiving an indication of a motion gesture, and/or the like in a manner such that the device may be perceived to be moved by a user. For example, the motion sensor 118 may comprise a three-axis accelerometer. In another embodiment, the motion sensor 118 may further comprise a gyroscope and magnetometer.

In some embodiments, the temporal relationship between a plurality of motion gestures may be measured. For example, the motion sensor 118 may be configured to enable the measurement of a temporal relationship between a plurality of motion gestures, such as with the assistance of the user interface 116. A motion gesture input may comprise a plurality of motion gestures to the motion sensor 118, such as a “P” gesture followed by a “Z” gesture. Alternatively, the motion sensor 118 may provide a time-stamped indication of a plurality of motion gestures to the processor 110 and the processor may, in turn, determine the temporal relationship. In another embodiment, the location of the device may be determined at the time of the motion gestures. For example, the motion sensor 118 may be configured to detect the location of the device during a user input comprising a motion gesture, such as with the assistance of the user interface 116. Alternatively, the motion sensor 118 may provide a time-stamped indication of a plurality of motion gestures to the processor 110 and the processor may, in turn, determine the location of the device, such as by reference to GPS signals or the like, at the time at which the motion gestures were detected. According to one embodiment, the start and end of a motion gesture may be determined. In this regard, the motion sensor 118 may be further configured to monitor the start and end of a particular motion gesture, such as with the assistance of the user interface 116. One embodiment of the present invention may include a motion sensor 118 configured to compare a vector magnitude or variance based three-axis accelerometer data with a pre-defined threshold limit to monitor the start and end of a particular motion gesture. The motion sensor 118 may further be in communication with one or more of the processor 110, memory 112, communication interface 114, and/or UI control circuitry 122.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, user interface 116, or motion sensor 118, such as via a bus.

The UI control circuitry 122 and/or the processor 110 may be configured to receive an indication of a motion gesture input to the motion sensor 118 and/or otherwise determine a motion gesture input to the motion sensor 118. In this regard, for example, the motion sensor 118 may be configured to detect a motion gesture input to the motion sensor 118 and generate a signal indicative of the motion gesture input. This signal may be received by the UI control circuitry 122 and/or the processor 110, which may determine the motion gesture input in response to receiving the signal. The signal may carry information indicative of a position, direction, path, duration, speed, and/or the like of the motion gesture input. The UI control circuitry 122 and/or the processor 110 may be further configured to cause an operation of the device based at least in part on the determined relation of the motion gesture input and a motion gesture library associated with a plurality of contextual states of the device.

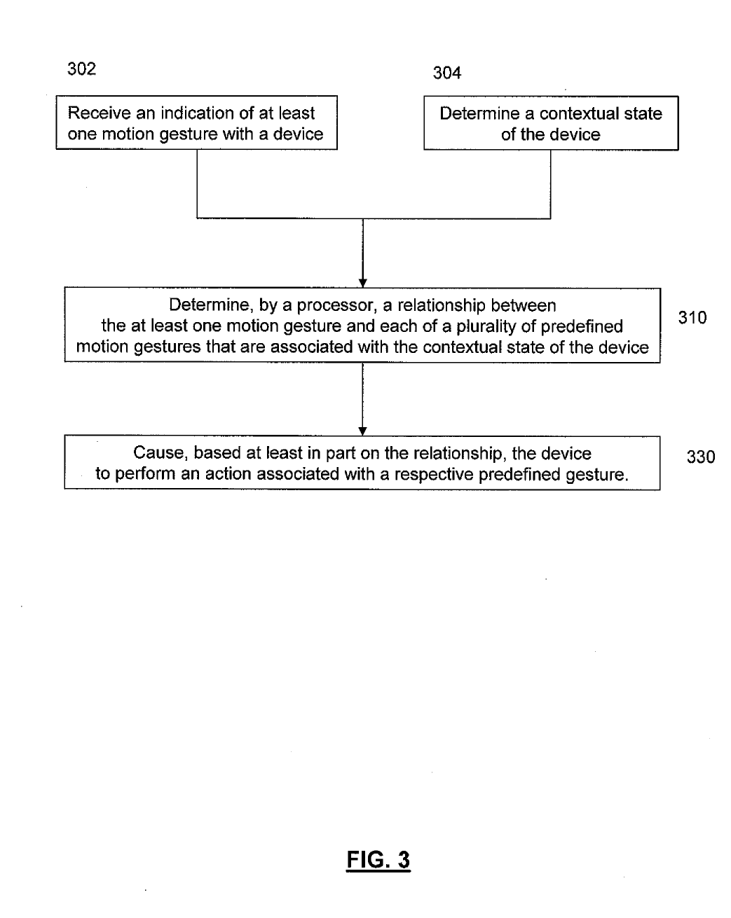

Referring now to FIG. 3, FIG. 3 illustrates an example interaction with an example device including a motion sensor and user interface according to an example embodiment. The device may include means, such as the motion sensor 118, the processor 110, the UI control circuitry 122 or the like, for receiving a motion gesture input provided by a user. See operation 302. In one embodiment of the invention, the motion sensor 118 may receive the motion gesture input when a user provides a predefined input that indicates a gesture input is to or is being performed, such as by engaging a physical button. According to another embodiment, the motion sensor 118 may continuously monitor for a motion gesture and may receive the motion gesture input automatically when a user performs a motion gesture that satisfies a predefined motion threshold, such as by comparing a vector magnitude or variance based three-axis accelerometer data with a pre-defined threshold. The motion sensor 118 may provide an indication of the motion gesture to the processor 110, the UI control circuitry 122 or the like for further processing so that the processor, the UI control circuitry or the like are also considered to have received an indication of the motion gesture input. Concurrent with receiving a gesture input, a contextual state of the device may be determined, such as by determining whether the user and the device is located at work, whether a device event has occurred, and/or the like. See operation 304. The contextual state may be determined by various means including the processor 110 in one embodiment.

As shown in FIG. 3, the gesture input that has been detected by the motion sensor 118 is compared to each of the plurality of gestures from the appropriate library of motion gestures associated with the particular contextual state of the device. See operation 310. The comparison may be performed by various means including, for example, the processor 110. The device of one embodiment may include means, such as the processor 110, for measuring the similarity between the motion gesture that has been detected by the motion sensor 118 and the plurality of motion gestures from the library with a Dynamic Time Warping algorithm. Alternatively, the device of one embodiment may include means, such as the processor 110, for measuring the similarity between the motion gesture that has been detected by the motion sensor 118 and the plurality of motion gestures from the library with a Hidden Markov Model algorithm. In other embodiments, the means for measuring the similarity between the motion gesture that has been detected by the motion sensor and the plurality of motion gestures from the library may include any pattern matching and statistical approach configured to provide a desired recognition accuracy, such as a decision tree algorithm, a maximum entropy classifier, neural networks, Naive Bayes classifier and/or the like as is known in the art of motion pattern matching, classifying and/or the like. According to one embodiment that includes comparing the motion gestures with a Dynamic Time Warping algorithm, a limit may be established for the amount of variation in gesture length between the motion gesture that has been detected by the motion sensor 118 and the catalogued motion gesture. Further, the Dynamic Time Warping algorithm may provide for measuring the normalized accumulated distance of each of the gesture that has been detected by the motion sensor 118 and the catalogued motion gestures.

Further, the device of one embodiment of the present invention may include means, such as the processor 110, for performing at least one action associated with the completed motion gesture sequence. See operation 330. Although examples have been provided above, the operations illustrated in and described with respect to FIG. 3 may, for example, be performed by, with the assistance of, and/or under the control of one or more of the processor 110, memory 112, communication interface 114, user interface 116, motion sensor 118, or UI control circuitry 122.

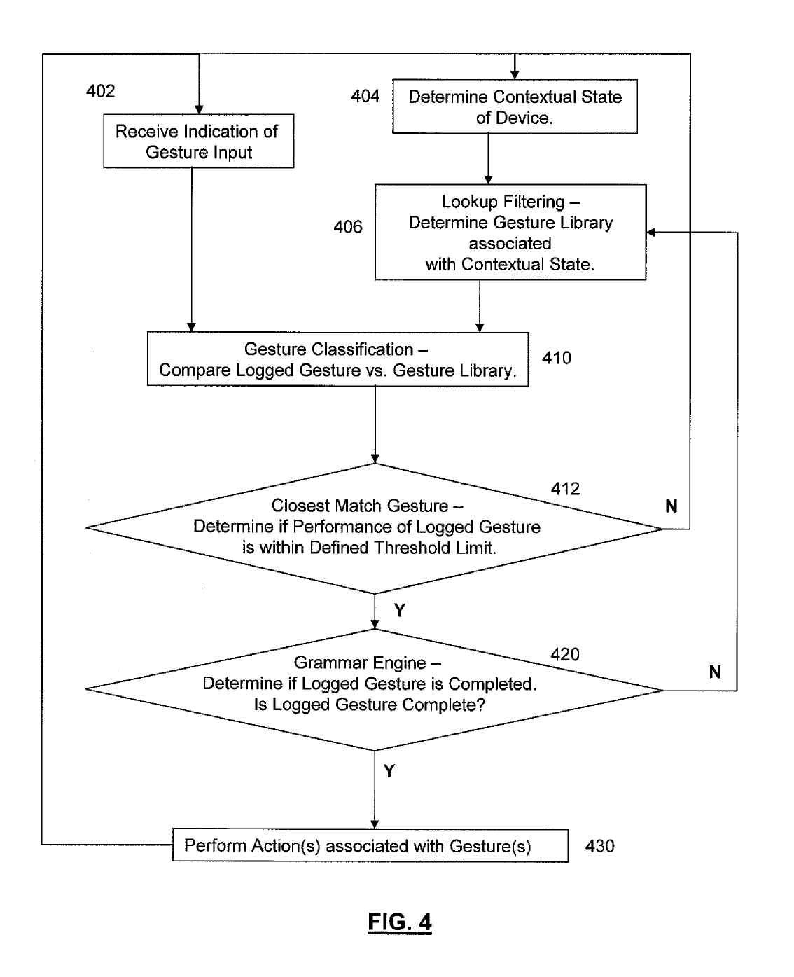

Referring now to FIG. 4, FIG. 4 illustrates an example interaction with an example device including a motion sensor and user interface according to an example embodiment. The device may include means, such as the motion sensor 118, the processor 110, the UI control circuitry 122 or the like, for receiving a motion gesture input provided by a user. See operation 402. In one embodiment of the invention, the motion sensor 118 may receive the motion gesture input when a user provides a predefined input that indicates a gesture input is to or is being performed, such as by engaging a physical button. According to another embodiment, the motion sensor 118 may continuously monitor for a motion gesture and may receive the motion gesture input automatically when a user performs a motion gesture that satisfies a predefined motion threshold, such as by comparing a vector magnitude or variance based three-axis accelerometer data with a pre-defined threshold. The motion sensor 118 may provide an indication of the motion gesture to the processor 110, the UI control circuitry 122 or the like for further processing so that the processor, the UI control circuitry or the like are also considered to have received an indication of the motion gesture input.

Concurrent with receiving a gesture input, a contextual state of the device may be determined, such as by determining whether the user and the device is located at work, whether a device event has occurred, and/or the like. See operation 404. The contextual state may be determined by various means including the processor 110 in one embodiment. As illustrated in FIG. 4, the device may include means, such as the processor 110, for determining the appropriate library of motion gestures associated with the particular contextual state of the device when the device receives a motion gesture input. See operation 406. According to one embodiment, the library of motion gestures may be created by the user training the device to associate certain motion gestures inputs to a particular contextual state. In another embodiment, the library of motion gestures may be previously provided such that a user may interact with the device in accordance with the previously provided motion gestures.

As shown in FIG. 4, the gesture input that has been detected by the motion sensor 118 is compared to each of the plurality of gestures from the appropriate library of motion gestures associated with the particular contextual state of the device. See operation 410. The comparison may be performed by various means including, for example, the processor 110. The device of one embodiment may include means, such as the processor 110, for measuring the similarity between the motion gesture that has been detected by the motion sensor 118 and the plurality of motion gestures from the library with a Dynamic Time Warping algorithm. Alternatively, the device of one embodiment may include means, such as the processor 110, for measuring the similarity between the motion gesture that has been detected by the motion sensor 118 and the plurality of motion gestures from the library with a Hidden Markov Model algorithm. In another embodiment, the device may include means, such as the processor 110, for measuring the similarity between the motion gesture that has been detected by the motion sensor 118 and the plurality of motion gestures from the library with known classifying methods configured to measure similarity between the detected motion gesture and the plurality of motion gestures. According to one embodiment that includes comparing the motion gestures with a Dynamic Time Warping algorithm, a limit may be established for the amount of variation in gesture length between the motion gesture that has been detected by the motion sensor 118 and the catalogued motion gesture. Further, the Dynamic Time Warping algorithm may provide for measuring the normalized accumulated distance of each of the gesture that has been detected by the motion sensor 118 and the cataloged motion gestures.

According to one embodiment, when a motion gesture that has been detected by the motion sensor 118 is classified as being similar to a catalogued motion gesture, the device may include means, such as the processor, for comparing the motion gesture that has been detected by the motion sensor 118 with the catalogued motion gesture to determine whether the gesture that has been detected by the motion sensor 118 is within a pre-defined threshold limit. See operation 412. In one embodiment, the pre-defined threshold limit may be based on repeated tests on several gestures with different users. If the gesture that has been detected by the motion sensor 118 is outside the pre-defined threshold limit, no further action is taken and a motion sensor may begin to receive a new motion gesture input. In another embodiment of the present invention, if the gesture that has been detected by the motion sensor 118 is within the pre-defined threshold limit, the device may include means, such as the processor 110, for further analyzing the gesture that has been detected by the motion sensor 118, such as with a grammar engine, to determine whether the gesture that has been detected by the motion sensor 118 is a single gesture or whether the gesture that has been detected by the motion sensor 118 is part of motion gesture sequence comprising a plurality of gestures. See operation 420. In one embodiment, the processor 110 may implement the grammar engine such that the grammar engine may be configured to determine whether a motion gesture input of a motion gesture sequence comprising a plurality of motion gestures is complete. Further, the device, according to one embodiment, may include means, such as the processor 110, for repeating the gesture classification 410, gesture threshold comparison 412 and grammar engine analysis 420 until the grammar engine indicates the motion gesture that has been detected by the motion sensor 118 corresponds to a complete motion gesture sequence comprising a plurality of motion gestures. Further, the device of one embodiment of the present invention may include means, such as the processor 110, for performing at least one action associated with the completed motion gesture sequence. See operation 430. Although examples have been provided above, the operations illustrated in and described with respect to FIG. 4 may, for example, be performed by, with the assistance of, and/or under the control of one or more of the processor 110, memory 112, communication interface 114, user interface 116, motion sensor 118, or UI control circuitry 122.

FIGS. 3 and 4 illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving an indication of at least one motion gesture made with a device;
determining a contextual state of the device;
determining, by a processor, a relationship between the at least one motion gesture and each of a plurality of predefined motion gestures that are associated with the contextual state of the device; and
causing, based at least in part on the relationship, the device to perform an action associated with a respective predefined gesture.

2. The method of claim 1 further comprising determining a motion gesture library associated with the contextual state of the device, the motion gesture library comprising a plurality of motion gestures.

3. The method of claim 1, wherein determining the relationship comprises determining a normalized accumulated distance between the at least one motion gesture and each of the plurality of predefined motion gestures that are associated with the contextual state of the device.

4. The method of claim 1, wherein receiving the indication of the at least one motion gesture comprises determining whether the at least one motion gesture is a complete single gesture or at least a portion of a gesture sequence.

5. The method of claim 4, wherein causing, based at least in part on the determined relationship, the device to perform an action further comprises causing the device to perform an action when the at least one motion gesture is determined to be complete.

6. The method of claim 1, wherein determining, by a processor, a relationship between the at least one motion gesture and each of a plurality of predefined motion gestures further comprises:
comparing the at least one motion gesture to each of the plurality of predefined motion gestures that are associated with the contextual state of the device;
associating the at least one motion gesture to a respective predefined motion gesture that is associated with the contextual state of the device; and
determining whether the at least one motion gesture is within a defined threshold limit of the respective predefined motion gesture.

7. The method of claim 6, wherein determining whether the at least one motion gesture is within the defined threshold limit comprises comparing the at least one motion gesture to the respective predefined motion gesture with at least one of a pattern matching and statistical classification approach.

8. An apparatus comprising at least one processor and at least one memory storing computer program code, wherein the at least one memory and stored computer program code are configured, with the at least one processor, to cause the apparatus to at least:
receive an indication of at least one motion gesture made with the apparatus;
determine a contextual state of the apparatus;
determine a relationship between the at least one motion gesture and each of a plurality of predefined motion gestures that are associated with the contextual state of the apparatus; and
cause, based at least in part on the determined relationship, the apparatus to perform an action associated with a respective predefined gesture.

9. The apparatus of claim 8, wherein the at least one memory and stored computer program code are configured, with the at least one processor, to cause the apparatus to determine a motion gesture library associated with the contextual state of the apparatus, the motion gesture library comprising a plurality of motion gestures.

10. The apparatus of claim 8 further comprising a motion sensor.

11. The apparatus of claim 8, wherein the at least one memory and stored computer program code are configured, with the at least one processor, to cause the apparatus to determine a normalized accumulated distance between the at least one motion gesture and each of the plurality of predefined motion gestures that are associated with the contextual state of the device.

12. The apparatus of claim 9, wherein the at least one memory and stored computer program code are configured, with the at least one processor, to cause the apparatus to determine whether the at least one motion gesture is a complete single gesture or at least a portion of a gesture sequence.

13. The apparatus of claim 9, wherein the at least one memory and stored computer program code are configured, with the at least one processor, to cause the apparatus to:
compare the at least one motion gesture to each of the plurality of predefined motion gestures that are associated with the contextual state of the device;
associate the at least one motion gesture to a respective predefined motion gesture that is associated with the contextual state of the device; and
determine whether the at least one motion gesture is within a defined threshold limit of the respective predefined motion gesture.

14. The apparatus of claim 12, wherein the at least one memory and stored computer program code are configured, with the at least one processor, to cause the apparatus to perform an action when the at least one motion gesture is complete.

15. A computer program product comprising at least one non-transitory computer-readable storage medium having computer-readable program instructions stored therein, the computer-readable program instructions comprising program instructions configured to cause an apparatus to perform a method comprising:
receiving an indication of at least one motion gesture made with a device;
determining a contextual state of the device;
determining a relationship between the at least one motion gesture and each of a plurality of predefined motion gestures that are associated with the contextual state of the device; and
causing, based at least in part on the determined relationship, the device to perform an action associated with a respective predefined gesture.

16. The computer program product of claim 15 configured to cause an apparatus to perform a method further comprising determining a motion gesture library associated with the contextual state of the device, the motion gesture library comprising a plurality of motion gestures.

17. The computer program product of claim 15, wherein determining the relationship comprises determining a normalized accumulated distance between the at least one motion gesture and each of the plurality of predefined motion gestures that are associated with the contextual state of the device.

18. The computer program product of claim 15, wherein receiving the indication of the at least one motion gesture comprises determining whether the at least one motion gesture is a complete single gesture or at least a portion of a gesture sequence.

19. The computer program product of claim 15, wherein determining a relationship between the at least one motion gesture and each of a plurality of predefined motion gestures that are associated with the contextual state of the device further comprises:
comparing the at least one motion gesture to each of the plurality of predefined motion gestures that are associated with the contextual state of the device;
associating the at least one motion gesture to a respective predefined motion gesture that is associated with the contextual state of the device; and
determining whether the at least one motion gesture is within a defined threshold limit of the respective predefined motion gesture.

20. The computer program product of claim 18, wherein causing based at least in part on the determined relationship, the device to perform an action further comprises causing the device to perform an action when the at least one motion gesture is determined to be complete.
